(19) United States
(12) Patent Application Publication
(10) Pub. No.: US 2003/0128186 A1
(43) Pub. Date: Jul. 10, 2003

(54) Foot-operated control for a computer

(76) Inventor: Kirk Laker, Felixstowe (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/364,057

(22) Filed: Feb. 11, 2003

Related U.S. Application Data
(63) Continuation of application No. PCT/GB01/03599, filed on Aug. 10, 2001.

(30) Foreign Application Priority Data
Aug. 11, 2000 (GB) 0019685.7

(51) Int. Cl. G09G 5/00

(52) U.S. Cl. 345/156

(57) ABSTRACT

The present invention provides a foot-operable computer input control device that enables a computer user to utilize their feet to control or interact with a computer game or software application. The device includes at least two bi-directional roller elements each providing a surface on which the user's foot can be placed. Linking means, e.g., a mechanical clutch, is provided to transfer rotational motion of one roller element to another roller element thereby creating a variable dynamic linkage. The rotational motion of the roller elements is detected by detection means such as an optical encoder and this results in the generation and sending of an output signal from signal output means to a computer input.

### CROSS-REFERENCE TO RELATED APPLICATIONS

This application is a continuation of International Patent Application No. PCT/GB01/03599 filed Aug. 10, 2001, which designated inter alia the United States and was published under PCT Article 21(2) in the English language.

### FIELD OF THE INVENTION

The present invention relates to a foot-operated controller for a computer, and in particular to a controller that enables a computer user to utilize their feet to control or interact with a computer game or software application.

### BACKGROUND OF THE INVENTION

The interaction between a computer and a user is typically accomplished in one of several ways. Most typically, the user's hands are used to control a positional screen indicator for example, by the use of a mouse, a keyboard, or a joystick. Less common but also known are foot switches, voice recognition, optical retinal positioning, accelerometers, and other physical and magnetic control devices for the control of the movement of a positional screen indicator or for functional screen movement.

Computer games have become increasingly complex and whilst such known controllers are effective in allowing a computer user to control many types of game, a user increasingly has to operate numerous buttons or other devices with his hands in order to control all aspects of a complex game. It can become difficult for a computer user to remember which control he should use, or the user may not have the manual dexterity to operate a range of hand-operated controls in quick succession as is often required.

It is an aim of the present invention to provide a computer input control device that ameliorates the above mentioned problems by allowing the user to use his feet to at least partially control or interact with a computer game or software.

The potential for the user to use foot control with computer programs has been previously recognised.

For example, in U.S. Pat. No. 5,913,684, a locomotion simulator for entertainment or training purposes is described. The simulator has two independently controlled foot pads which track the position of a user's feet as he walks or runs, the foot pads moving into position under the user's feet. The pads are rotatable to allow simulation of turning or rotating.

U.S. Pat. No. 5,334,997 discloses a foot operated input device which is similar to a conventional hand operated mouse but that is designed for use with the user's feet. The device includes a housing having two sections each containing a roller ball and foot switches.

U.S. Pat. No. 5,225,804 discloses a device comprising a belted roller which can be rotated by a user's foot to control a potentiometer, the device designed for use in a classroom so that a teacher can gauge the pupils' response to the lesson by the movement of their feet.

Finally, U.S. Pat. No. 5,777,602 discloses a surgical device which has a foot roller and foot switches which can be used by a surgeon to control various elements during surgery.

Despite the existence of these known systems, there is still a need for a simple yet versatile device for control of a computer game or software by a user's foot.

### SUMMARY OF THE INVENTION

Accordingly, in a first aspect, the present invention provides a computer input control device comprising:

at least two bi-directional roller means, each roller means having at least one roller and a foot engaging surface for engagement with a user's foot;

linking means for creating a variable dynamic linkage between one roller means and another roller means by transfer of rotational motion;

detection means for detecting rotational motion of said at least one roller of said roller means; and

a signal output means supplying an output signal dependent upon said rotational motion to a computer input.

In some embodiments, the device further includes a housing, each roller means being supported within the housing.

In its simplest form, each roller means comprises a cylindrical roller, the outer surface of which presents the foot-engaging surface. These are preferably co-axially mounted in the housing so that the user can comfortably use the device with his feet side by side. Preferably, the cylindrical rollers would be set within the housing such that most of each roller is concealed by the housing. This simple form of roller means is suitable for games where, for example, use of a scooter or skateboard must be simulated.

Alternatively, the rollers may be conical or bowed, i.e., curved along the outer surface parallel to their mounting axis, rather than cylindrical.

In some embodiments, each roller comprises at least two cylindrical rollers connected by a belt such as a looped belt which can be used to simultaneously drive the rotation of the two or more cylindrical rollers. The belt itself would provide the foot-engaging surface on which a user may place his foot. This type of roller means is more suitable for games in which a walking or running motion must be simulated.

In cases where a belt is provided to link two or more cylindrical rollers, a low friction plate can be provided behind the belt at the position where the user's foot will contact the belt to help support the weight of the user's foot. Alternatively, there may be a number of idler rollers in place of the plate, again to support the weight of the user's foot.

In particular embodiments, the roller means provided with surface manipulation means for manipulating the surface profile of the foot-engaging surface. This is to provide the user with realistic sensations of walking or running over different types of ground. For example, if, in the game play, the character controlled by the user is walking over smooth ground such as concrete, the surface profile of the foot engaging surface would be smooth whereas, if, in the game play, the character controlled by the user is walking over rough terrain such as gravel, the surface profile can be manipulated to have a rough profile. This rough profile can be achieved, for example, by using retractable pegs or pins that project either from the cylindrical roller itself (in the case of the simplest form of the roller means) or from a plate underneath the belt below the foot-engaging surface.

In some embodiments rotational motion of one or more of the roller(s) of or more of the roller means is constrained beyond a certain position, i.e., angle from a resting position. Additionally or alternatively, the roller(s) of one or more of the roller means may be biased to return to the resting position, for example by providing a spring return unit to the roller(s) of the or each roller means. This unit may comprise, for example, a coiled spring which is stretched or compressed as the roller means is rotated from the resting position such that the tension in the stretched spring or the compression in the compressed spring causes the roller means to return to the resting position once the user's foot is removed from the roller means. This enables the user to vary progressive differential controls such as would be used in a tank or other tracked vehicle game or as a control for the rudder in a flight simulation game. Each spring return unit can be engaged/disengaged, for example, by a knob or lever.

In other embodiments of the invention, one or more of the roller means can freewheel once a user has started the roller(s) moving in one or other rotational direction. An example of use of this embodiment would be where the device has to simulate use of a skateboard, roller or ice skates or a scooter, i.e., in cases where the motion incorporates some degree of momentum.

In some embodiments, resistance means may be applied to the roller(s) of one or more of the roller means. This is to allow an increase or decrease in the ease with which the user can impart rotational motion to the roller(s). For example, if, in the game play, the character controlled user is ascending an incline or moving through a resistant medium such as mud, the resistance applied to the or each roller is increased so that the user needs to exert a greater force to rotate the or each roller. Alternatively, if, in the game play, the character controlled by the user is descending an incline or being carried along by a water current, the resistance on the or each roller can be decreased to decrease the amount of effort needed by the user to rotate the roller(s).

In some embodiments, the resistance means is provided by a motor and brake assembly attached to each roller means. Preferably, the or each assembly includes a gear box to achieve different degrees of resistance.

The linking means in the present invention provide a variable dynamic linkage between one roller means and the other roller means by transfer of rotational motion. This allows a varying degree of synchronicity between the roller means. The dynamic linkage is variable between 0% and 100% and depends on the environment in which the game play occurs.

For example, if, in the game play, the character controlled by the user is moving over concrete the dynamic linkage will be set at 100%, i.e., the movement of the roller(s) of one roller means will be entirely synchronised with the movement of the roller(s) of the other roller means so that the foot engaging surfaces simulate the movement under foot of the concrete surface as the user moves over it in the game.

Similarly, if, in the game play, the character controlled by the user is moving over ice, the dynamic linkage will be set at a minimum, perhaps as low as 0% so that the movement of the roller(s) of one roller means is completely unlinked to the movement of the other so that the foot engaging surfaces simulate the movement under foot of the ice surface as the character controlled by the user moves over it in the game play.

It can be seen that the degree of variable linkage can be varied across the entire range between 100 and 0% depending on the surface in the game play. For example, whilst it is set at 100% for concrete as mentioned above, it can be set at 50% for wet concrete which will be more slippery underfoot.

In some embodiments, the linkage means is provided by a clutch. This can be a physical, mechanical clutch or, alternatively, it can be a “virtual clutch” as will be described later.

Where a physical clutch is employed, the clutch can comprise, for example, an electronic clutch comprising two sets of magnetic coils interspaced with a friction plate, for example, a TEFLON® (polytetrafluoroethylene) plate, one magnetic coil being associated with each roller means.

The variable dynamic linkage is provided by varying the slippage of the mechanical clutch.

Alternatively, there may be no physical clutch but, instead, the linkage means may comprise a “virtual clutch” which is achieved using a motor/generator and brake assembly associated with each roller means, the assembly being controlled by a signal output from computer software.

In this case, the user moves the roller(s) of one of the roller means and the motion is detected by the detection means which causes the signal output means to generate a signal which is supplied to a computer input. The computer software processes the signal and sends a signal back to the motor/brake assembly associated with the roller means with roller(s) not moved by the user to cause it/them to move in some degree of synchronicity with the roller(s) driven by the user. Again, the degree of linkage is variable and the computer software which generates the signal to drive the motor/brake assemblies can generate variable signals which dictate the degree of linkage. The degree of linkage will be determined in the same way as for embodiments having a physical clutch, for example, 100% for concrete, 50% for wet concrete and 0% for ice.

Preferably, the motor/brake assemblies will have a gear box to facilitate the variable degree of synchronicity between the roller means.

It should be noted that the motor/brake assemblies used in a “virtual clutch” can be the same motor/brake assemblies used for the resistance means.

Use of the motor/brake assemblies, either as resistance means (when there is either a physical or “virtual clutch”) or as part of the “virtual clutch” itself leads to what is described as an active powered mode of the device whilst use of a physical clutch alone with no motor/brake assemblies leads to the device being used in manner described as a passive, unpowered mode.

When the user uses the device, for example to simulate a running or walking action, the bipedal action is translated into a single axial movement in one direction, until the roller(s) of one or both roller means are either stopped and/or reversed. For example, if, in the game play, the character controlled by the user is required to turn left, the user will maintain the right hand roller(s) in a stationary position and use his left foot to rotate the left hand roller(s) forwards away from himself. Alternatively, the user could maintain the left hand roller stationary and use his right foot to rotate the right hand roller(s) backwards towards himself. Either of these actions will create a turning moment relative to the axial movement line such that the output will consist of motion in two axes, the output varying in accordance with the differential between the roller(s) of the roller means. Thus the relative movement of the roller(s) of one roller means to the other allows for control of the game play.

The detection means of the present invention may be any means capable of detecting the motion of the roller(s) of the roller means. As one example, the detection means can comprise an optical encoder. This could be a light reflecting or light detecting unit. Alternatively, the detection means may comprise a magnetic induction unit, physical cam or micro-switch.

In some embodiments of the device, the roller means are capable of sideways, lateral movement along the axes of rotation of the roller(s). The roller means may be laterally moveable independently of each other or, alternatively, the at least two roller means may be moveable together as a single unit. This allows the simulation of sideways movement within the game play. The lateral movement is preferably detected by sensor means. For instance, the lateral movement of the roller means can be detected using pressure sensor means. For example, pressure sensor means may be provided on the housing, in contact with at least part of outside faces of the at least two roller means. As the roller means move laterally, e.g., as a single unit, the pressure exerted on the pressure sensor means will either increase or decrease depending on the direction of the lateral movement and this change in pressure will generate a signal which may be sent by the signal output means to the computer input to control sideways movement within the game play.

Preferably, the at least two roller means are pivotable about an axis perpendicular to the axes of rotation of the roller(s). The roller means may be pivotable individually or together as a single unit. Preferably, there is provided pivoting sensor means such as a tilt sensor to detect the pivoting and to cause the signal output means to generate and send to the computer input a signal to control tilting motion within the game play. An example of a game in which such a tilting motion may be desirable is a game involving snowboarding, skiing or skateboarding.

In a second aspect, the invention provides a games system comprising:

a device as any one embodiment described above;

computer processing means for receiving and outputting signals from and to said device; and

a visual display unit for displaying the game play controlled by said device.

The computer processing means and visual display unit may be entirely standard.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a sectional view of first embodiment;

FIG. 2 is a sectional view of a second embodiment;

FIG. 3 is a sectional view of a third embodiment;

FIG. 4A is a front view of the first, second or third embodiment with the housing removed to show the working parts of the device;

FIG. 4B is a front view of an embodiment in which lateral movement of the roller means is possible.

FIG. 4C is a top view of an embodiment in which pivoting of the roller means is possible.

FIG. 4D is an example of a roller lock assembly.

FIGS. 5 to 10 are plan views of the device showing variants of the device using multiple sets of rollers and belts; and

FIG. 11 is a schematic diagram showing one embodiment of the second aspect of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

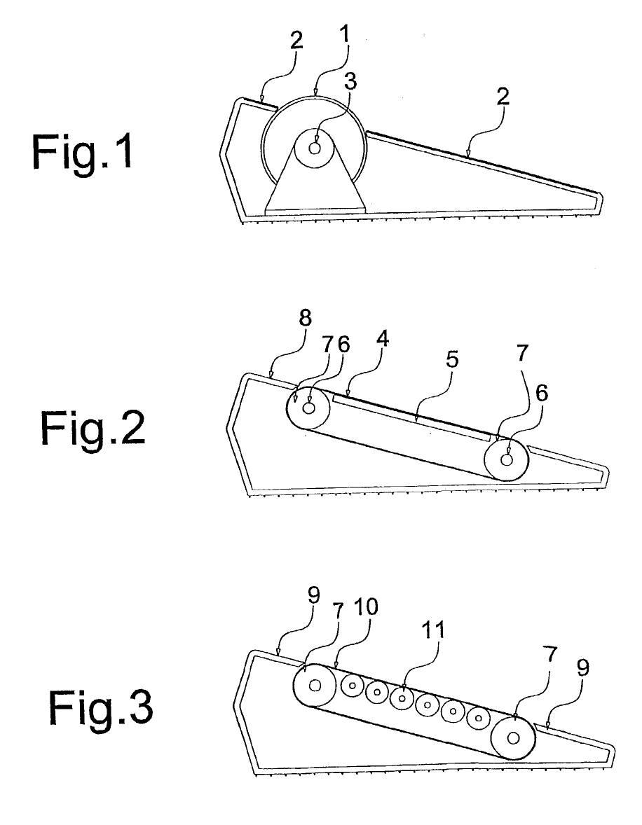

FIG. 1 shows a first embodiment of the present invention where the roller means (only one shown in FIG. 1) are in the simplest form and each comprise a cylindrical roller 1. The rollers 1 are mounted within a housing 2 that is used within the general vicinity of the user's feet. The rollers are mounted along their longitudinal center line on an axle 3 and may be free to rotate or may be held by some form of mechanical or dynamic brake or may be powered by an active motor/generator assembly.

FIG. 2 shows a second embodiment of the roller means. A looped belt 4 which is rectangular in its construction is supported between two cylindrical rollers 7 mounted on shafts 6 within a housing 8, and is supported in its flat working plane by a carrier plate 5. This plate is a low friction plate which is positioned underneath the belt at the location of the foot-engaging surface to bear the weight of the user's foot. This plate may have retractable pegs or pins with can be raised as desired to manipulate the surface profile of the foot-engaging surface to simulate various different terrains.

FIG. 3 shows a third embodiment of the roller means. A looped belt 10 which is rectangular in its construction is supported between two rollers 12 mounted on a shaft within a housing 9, and is further supported along its length by further idler rollers 11. Again, these idler rollers are to support the weight of the user's foot at the foot engaging-surface.

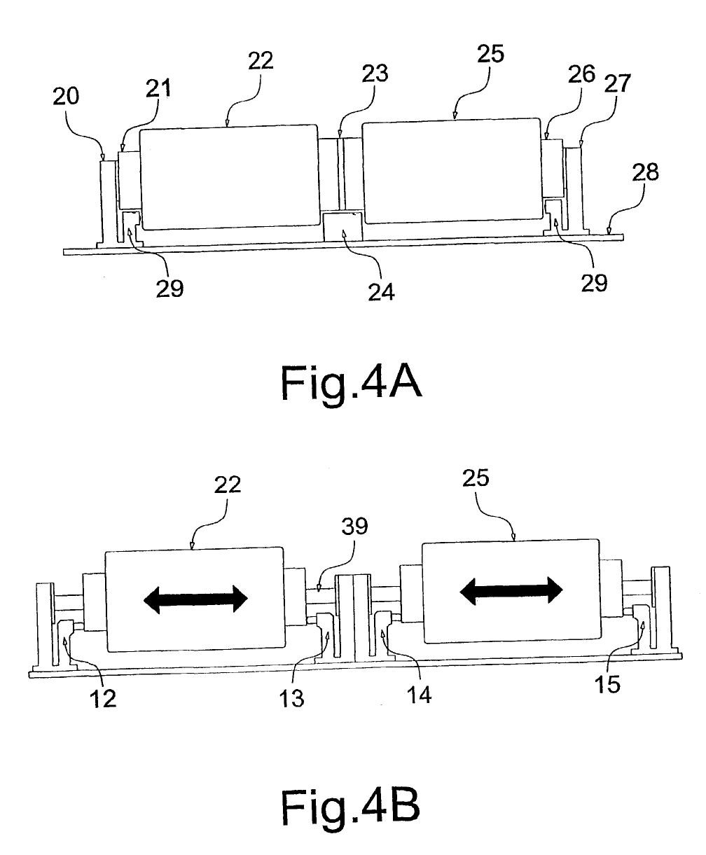

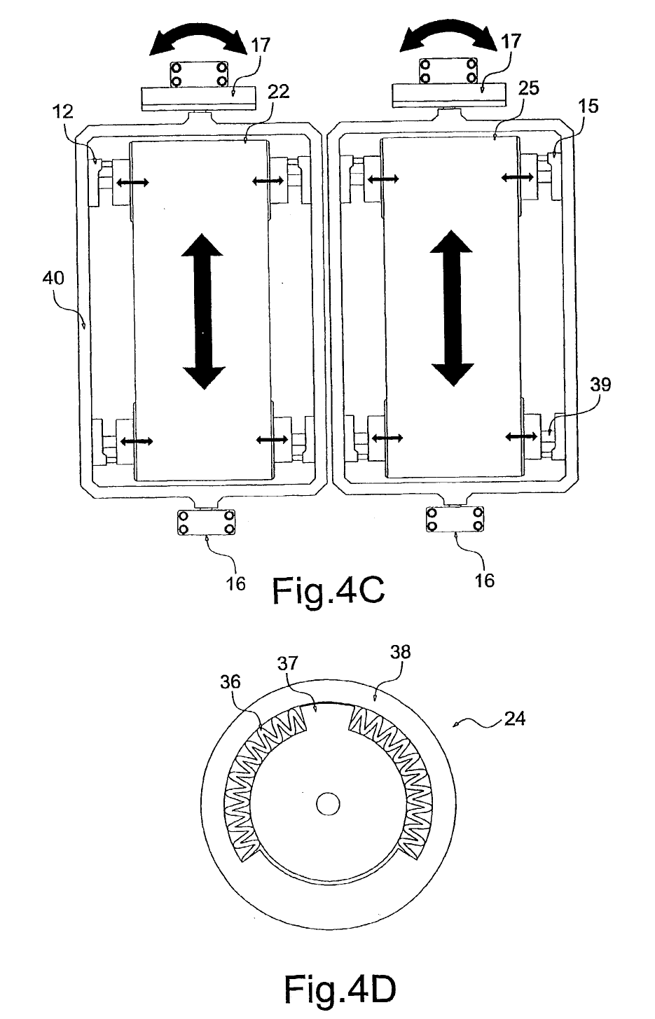

FIG. 4A is a cross-section through one embodiment of the device. Roller means 22, 25, which may be simple rollers as shown in FIG. 1 or may be rollers supporting a looped belt as shown in FIGS. 2 and 3, are supported by a shaft assembly 20,27 in a housing 28 and are connected by a physical clutch assembly 23. The clutch assembly comprises two magnetic discs separated by a friction plate such as a TEFLON® disc. One disc is associated with each of the two roller means so that rotational movement of the roller(s) of one roller means can be transferred to the roller(s) of the other roller means. Motor/brake assemblies 21, 26 are used to increase or decrease resistance to the rotation of the respective roller(s) to simulate various situations in the game play, e.g., ascending or descending an incline. The computer software of the game will control the amount of resistance applied by motor/brake assemblies which may, optionally, have gear boxes.

Sensors 29 are provided to detect the rotational motion of the roller(s) of each roller means. The sensor is an optical element which detects black/white encoded signal carried on the end of each roller.

A roller lock assembly 24 is also provided in some embodiments to limit the rotational motion of one or more of the rollers.

FIG. 4B shows a cross-section through another embodiment of the device in which the roller means 22, 25 are moveable laterally in a sideways direction. Each roller means, which may be a simple cylindrical roller or may be at least two cylindrical rollers having a looped belt, is mounted on an axis 39 (or two axes in the case of a roller means having two cylindrical rollers and a looped belt) about which the roller(s) of the roller means is/are rotatable. The roller means are also slidable along this axis/these axes to allow simulation of sideways motion in the game play. Associated with each roller is at least one pressure sensor 12, 13, 14, 15. In the embodiment shown in FIG. 4B, the roller means are moveable laterally independently of each other and therefore, each roller means has a sensor located at either side of the means. In some embodiments, where the roller means are moveable together as a single unit, a reduced number of pressure sensors is sufficient, for example pressure sensors 12, 15 are only required on the outside faces of the rollers.

In FIG. 4B, each pressure sensor is in contact with the respective roller means 22, 25 so that as the element moves laterally, either more or less pressure is applied to the pressure sensor and this change in pressure can be converted into a signal which is sent via the signal output means to the computer input to control sideways movement in the game play.

Both FIGS. 4B and 4C show embodiments using a “virtual clutch” i.e., there is no mechanical clutch. Dynamic linkage of the two roller means is maintained using motor/brake assemblies (not shown in FIGS. 4B and 4C).

FIG. 4C shows yet another embodiment in which the roller means 22, 25 each comprise two rollers rotationally connected via a looped belt. In this embodiment, the roller means are moveable laterally along the axes of rotation 39 as in FIG. 4B.

The roller means are also pivotable about an axis at right-angles to the axes of rotation. Each roller means is contained within a support member 40 from which extends two axles which are received in and rotatable within a respective bearing assembly 16 at either end of each support member. This allows the pivoting motion of roller means along with its support member. Tilt sensors 17 are provided to detect the pivoting motion thus generating a signal which is sent by the signal output means to the computer input to control tilting motion, e.g., in a snowboarding game.

FIG. 4D shows an example of a roller lock assembly for limiting the extent of rotation of a roller and for returning the roller to a resting position. The assembly comprises an outer rotor 38 which is rotatable with the roller to which it is attached. The inner member 37 is fixed relative to the roller so that it does not rotate as the roller rotates. Connected between the outer rotor and the inner member are two helical springs 36. As the roller rotates, the outer rotor rotates and one spring is compressed whilst the other is extended. Rotation of the roller and outer rotor is prevented once the maximum compression and/or the maximum extension is achieved in the springs. Alternatively, a tab may be provided on either one of the rotor or inner member which abuts a second tab on the other of the rotor or inner member to prevent further rotation.

Once the user's foot is released form the foot-engaging surface on the roller means, the extension and compression in the springs causes the roller to return to its resting position.

In even more simple roller lock assemblies, only a single spring is provided.

Various modes of operation of the device will now be described.

In some embodiments, the roller(s) of the roller means 22, 25 are able to rotate freely once rotational motion has been initiated by a user's foot. The device may have a physical clutch 23 as shown in FIG. 4A or may have a “virtual clutch” as in FIGS. 4B and 4C.

In use, the device is positioned within working distance of the user's feet and connected to the computer or game console. The roller means 22, 25 are coupled together by a clutch (physical or “virtual”) enabling the motion of each roller means to interact with the other, i.e., creating a dynamic linkage, and giving the effect of the roller(s) of both roller means being rotated as if they were one. The user can then use a walking or running action to move through a game or software application in a single dimension. If the roller(s) of one roller means is held by a foot and the roller(s) of the other roller means is rotated by the other foot, this will result in a differential turning moment being produced which may be used to turn the player in a game or move the cursor or screen graphic within a software application.

As the roller(s) of the roller means 22, 25 are rotated by the user, sensors 29 detect the rotational movement of each roller and this is used to produce a signal to the computer or game console, to influence the progression of the software application or game. When the roller(s) of both roller means are rotated in a ‘forward’ direction, i.e., towards the user, the output from the device will provide movement in one axis of the game or software application. When the roller(s) of both roller means are rotated in a ‘backward’ direction, i.e., away from the user, the output from the device will provide movement in one axis of the game or software application in the reverse direction. When the roller(s) of one roller means is held stationary against the other then the output from the device consists of motion in two axes and varies in accordance with the differential between the rollers.

In other embodiments, the roller(s) of the roller means are not able to rotate freely and are constrained in their angular rotation either in an active or passive mode, and returned by a self-centering device (e.g., the roller lock assembly 24) to resting positions.

In these embodiments, the device is positioned within working distance of the operator's feet and connected to the computer or game console. The roller(s) of the roller means 22, 25 are restrained from rotating freely by the roller lock assembly 24. This enables the operator to use the device to control accelerated functions within the game or software application. As the rollers are rotated by the user against the spring tension of the roller lock assembly, the output from sensors 29 is used to produce a signal to the computer or game console, to influence the progression of the software application or game.

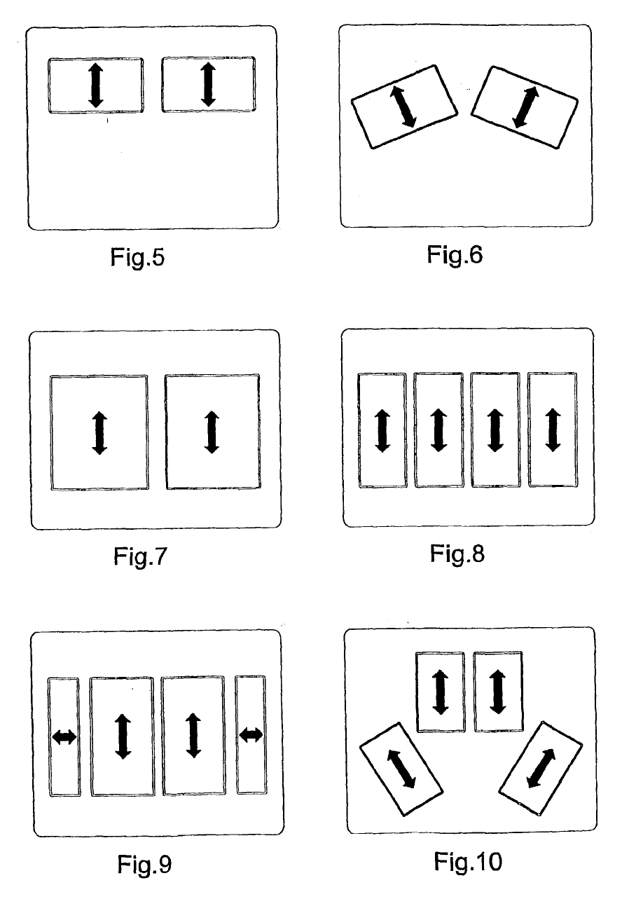

FIGS. 5 to 10 show various layouts of roller means in a housing. It can be seen that the number of roller means is not limited to two. The arrows on the roller means indicate the possible direction of rotational movement. Various foot switch elements could also be provided on the housing.

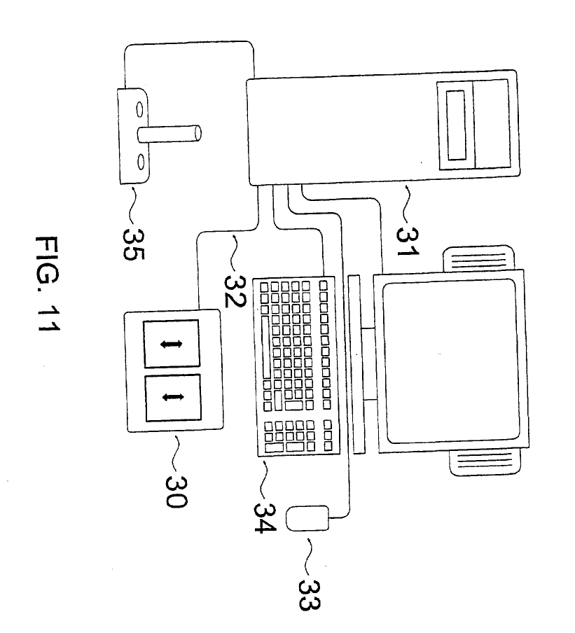

FIG. 11 shows an embodiment of the second aspect of the present invention. The device 30 is connected to the computer processing means 31 which may be a computer or game console. Communication for the input and output to and from the device and the computer processing means is provided via a cable 32, infrared link, radio link or some other means of transmission of data. The device may be used in connection with a mouse 33, a keyboard 34, a joystick 35, or other forms of control system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer input control device comprising:
at least two bi-directional roller means, each roller means having at least one roller and a foot engaging surface for engagement with a user's foot;
linking means for creating a variable dynamic linkage between one roller means and another roller means by transfer of rotational motion;
detection means for detecting rotational motion of said at least one roller of said roller means; and
a signal output means supplying an output signal dependent upon said rotational motion to a computer input.

2. The device according to claim 1 wherein the linking means can create a dynamic linkage that is variable between 0% and 100%.

3. The device according to claim 1 wherein said linking means comprises a clutch disposed between at least two of the roller means.

4. The device according to claim 1 wherein said linking means comprises at least two motor/brake assemblies associated with a respective one of said roller means, each motor being controlled by a computer output.

5. The device according to claim 4 wherein said computer output is dependent on the signal output to the computer input.

6. The device according to claim 1 further comprising resistance means to create variable resistance to the rotation of said at least one roller of said roller means.

7. The device according to claim 6 wherein said resistance means includes at least two motor/brake assemblies associated with a respective roller means.

8. The device according to claim 7 wherein said motor/brake assemblies includes a gear box.

9. The device according to claim 1 wherein at least one roller means is a cylindrical roller (1).

10. The device according to claim 1 wherein at least one roller means comprises at least two cylindrical rollers linked by a belt, said belt providing said foot-engaging surface.

11. The device according to claim 10 further including a low friction plate behind said belt for bearing the weight of the user's foot in use.

12. The device according to claim 10 further including idler rollers behind the foot-engaging surface for bearing the weight of the user's foot in use.

13. The device according to claim 1 wherein one or more of said at least one roller of said roller means can free-wheel once rotational motion is commenced.

14. The device according to claim 1 wherein rotational motion of one or more of said at least one roller is constrained beyond a certain point.

15. The device according to claim 14 wherein said one or more of said at least one roller is biased to return to a resting position.

16. The device according to claim 1 further including surface manipulation means for manipulating the surface profile of said foot-engaging surface.

17. The device according to claim 16 wherein said surface manipulation means includes retractable projections on a plate positioned under the foot-engaging surface.

18. The device according to claim 1 further comprising a housing for supporting said at least two roller means.

19. The device according to claim 1 wherein said at least two roller means are laterally moveable along the axes of rotation of the respective at least one roller.

20. The device according to claim 1 wherein said at least two roller means are pivotable about at axis perpendicular to the axes of rotation of the respective at least one roller.

21. A games system comprising:
a device according to claim 1 for controlling game play;
computer processing means for receiving and outputting signals from and to said device; and
a visual display unit for displaying the game play controlled by said device.
